(19) United States
(12) Patent Application Publication
(10) Pub. No.: US 2026/0237723 A1
(43) Pub. Date: Aug. 13, 2026

(54) POSITIVE ELECTRODE AND LITHIUM-ION SECONDARY BATTERY

(71) Applicant: TOYOTA JIDOSHA KABUSHIKI KAISHA, Toyota-shi (JP)

(72) Inventor: Yudai HASEGAWA, Toyota-shi (JP)

(73) Assignee: TOYOTA JIDOSHA KABUSHIKI KAISHA, Toyota-shi (JP)

(21) Appl. No.: 19/453,409

(22) Filed: Jan. 20, 2026

(30) Foreign Application Priority Data
Feb. 13, 2025 (JP) 2025-021844

(51) Int. Cl. H01M 10/0525; H01M 4/02; H01M 4/136; H01M 4/36; H01M 4/58

(52) U.S. Cl. CPC H01M 10/0525; H01M 4/136; H01M 4/366; H01M 4/5825; H01M 2004/028

(57) ABSTRACT

There is provided a positive electrode of a lithium-ion secondary battery, the positive electrode including: a first region facing a separator; and a second region facing a current collector, in which the first region contains a first lithium manganese iron phosphate represented by Formula (1) as a general formula, the second region contains a second lithium manganese iron phosphate represented by Formula (2) as a general formula, and a<c.

is Li_{α}MnₐFe_{b}PO₄ (0.50≤α≤1.5, 0<a<1.0, 0<b<1.0, 0.9≤a+b≤1.1). Formula (1)

Formula (2) is LiβMn_{c}Fe_{d}PO₄ (0.50≤β≤1.5, 0<c<1.0, 0<d<1.0, 0.9≤c+d≤1.1). Formula (2)

### CROSS-REFERENCE TO RELATED APPLICATION

This application claims priority to Japanese Patent Application No. 2025-021844 filed on Feb. 13, 2025. The disclosure of the above-identified application, including the specification, drawings, and claims, is incorporated by reference herein in its entirety.

### BACKGROUND

### 1. Technical Field

The technology disclosed in the present specification relates to a positive electrode, a lithium-ion secondary battery, and the like.

### 2. Description of Related Art

As an active material for a positive electrode of a lithium-ion secondary battery, an olivine-type compound such as LiMnFePO₄ (LMFP) is used. Japanese Unexamined Patent Application Publication No. 2021-009838 (JP 2021-009838 A) describes, for the purpose of improving energy density and cycle stability, using granulated bodies of Mn-rich LMFP and Fe-rich LMFP as positive electrode active material particles.

### SUMMARY

The method of JP 2021-9838 A is intended to combine Mn-rich LMFP that contributes to energy density and Fe-rich LMFP that contributes to cycle stability. However, according to the present inventors, there still remains room for improvement in cycle characteristics.

The present specification provides a positive electrode and a lithium-ion secondary battery that improve cycle characteristics by effectively suppressing Mn elution.

The technology disclosed in the present specification is embodied in the following positive electrode and lithium-ion secondary battery.

1. A positive electrode of a lithium-ion secondary battery,
the positive electrode including:
a first region facing a separator; and
a second region facing a current collector,
in which the first region contains a first lithium manganese iron phosphate represented by Formula (1) as a general formula, the second region contains a second lithium manganese iron phosphate represented by Formula (2) as a general formula, and a<c,

$${Li}_{α} {Mn}_{a} {Fe}_{b} {PO}_{4} ( 0.5 \leq α \leq 1.5 , 0 < a < 1. , 0 < b < 1. , 0.9 \leq a + b \leq 1 \text{.1} ) \qquad Formula ( 1 )$$

$${Li}_{β} {Mn}_{c} {Fe}_{d} {PO}_{4} ( 0.5 \leq β \leq 1.5 , 0 < c < 1. , 0 < d < 1. , 0.9 \leq c + d \leq 1 \text{.1} ) . \qquad Formula ( 2 )$$

2. The positive electrode according to 1, in which, in the Formula (1), 0<a<0.80 and 0.20<b<1.0, and in the Formula (2), 0.70 c≤1.0 and 0≤d 0.30.

3. The positive electrode according to 2, in which, in the Formula (1), 0≤a≤0.60 and 0.40≤b<1.0.

4. The positive electrode according to 3, in which, in the Formula (1), 0.55≤a≤0.65 and 0.35≤b≤0.45, and in the Formula (2), 0.75≤c≤0.85 and 0.15≤d≤0.25.

5. A lithium-ion secondary battery including the positive electrode according to any one of 1 to 4.

In the positive electrode, the Mn ratio a of the LMFP in the first region on a separator side is smaller than the Mn ratio c of the LMFP in the second region on a current-collector side. Therefore, the Mn elution can be suppressed on the separator side in contact with the electrolyte, thereby contributing to excellent cycle characteristics. In addition, since the secondary battery includes the positive electrode, excellent cycle characteristics can be exhibited.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a cell of a lithium-ion secondary battery;

FIG. 2 is a cross-sectional view schematically showing an example of a structure of an electrode disclosed in the present specification; and

FIG. 3 is a process diagram schematically showing an example of a manufacturing method of an electrode sheet disclosed in the present specification.

### DETAILED DESCRIPTION OF EMBODIMENTS

The disclosure of the present specification relates to a positive electrode for a lithium-ion secondary battery, a lithium-ion secondary battery, and the like. According to the positive electrode disclosed in the present specification, without using composite particles made of LMFPs having different elemental ratios, Mn elution can be suppressed and excellent cycle characteristics can be obtained by a simple structure that provides LMFPs having different Mn elemental ratios on the separator side and on the current-collector side.

In addition, since the Mn ratio a of the LMFP in the first region on the separator side is low, it is possible to reduce resistance by avoiding low electron conductivity that is a disadvantage of Mn-rich LMFP.

Hereinafter, the positive electrode, the lithium-ion secondary battery, and the like will be described with reference to the drawings as appropriate.

### Positive Electrode of Lithium-Ion Secondary Battery

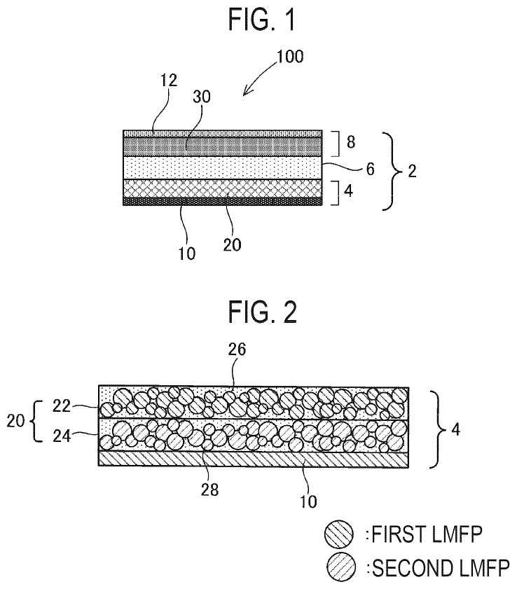

FIG. 1 schematically shows an example of a cell 2 of a lithium-ion secondary battery (hereinafter, simply referred to as a secondary battery) 100. As shown in FIG. 1, the cell 2 as a unit structure of the secondary battery 100 includes a positive electrode 4, a separator 6, and a negative electrode 8. The cell 2 further includes a positive electrode current collector 10 and a negative electrode current collector 12. The secondary battery 100 normally has a structure in which a plurality of cells 2 are laminated. The separator 6 may retain, for example, a liquid or gel electrolyte. The separator 6 is made of a known material such as a polyolefin-based microporous film having fine pores. The separator 6 is impregnated with a liquid electrolyte containing a lithium salt such as lithium hexafluorophosphate, using an organic solvent such as ethylene carbonate (EC), dimethyl carbonate (DMC), diethyl carbonate (DEC), or the like as a medium. Instead of these, a solid electrolyte layer may be used. The negative electrode 8 includes a negative electrode composite layer 30.

FIG. 2 schematically shows an example of a cross-section of the positive electrode 4. The positive electrode 4 includes a positive electrode composite layer (hereinafter, also simply referred to as a composite layer) 20. The positive electrode 4 may also be intended in a form including the current collector 10 integrated with the composite layer 20. The current collector 10 is not particularly limited, but examples thereof include a metal or alloy foil containing aluminum, nickel, or the like.

As shown in FIG. 2, in the secondary battery 100, the composite layer 20 includes a first region 22 facing the separator 6 and a second region 24 facing the current collector 10. The first region 22 and the second region 24 may be provided to divide the composite layer 20 into two in the thickness direction, or a region containing a positive electrode active material with any composition may be provided between the first region 22 and the second region 24.

The first region 22 and the second region 24 contain a positive electrode active material, respectively. Both the first region 22 and the second region 24 contain lithium manganese iron phosphate (LMFP) as a positive electrode active material. The first region 22 and the second region 24 contain a first LMFP 26 represented by Formula (1) as a general formula and a second LMFP 28 represented by Formula (2) as a general formula, respectively.

The first LMFP 26 is represented by Formula (1), the second LMFP 28 is represented by Formula (2), and further a<c.

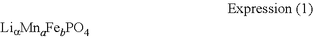

$$( 0.50 \leq α \leq 1.5 , 0 < a < 1. , 0 < b < 1. , 0.90 \leq a + b \leq 1.1 )$$

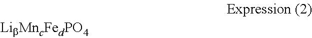

$$( 0.50 \leq β \leq 1.5 , 0 < c < 1. , 0 < d < 1. , 0.90 \leq c + d \leq 1.1 )$$

As is apparent from the above general formulas, the Mn ratio a as a ratio of Mn in Formula (1) is characterized in that it is smaller than the Mn ratio c as a ratio of Mn in Formula (2).

By having “Mn ratio a<Mn ratio c”, the amount of Mn eluted from the positive electrode 4 can be effectively reduced. Although the present specification is not limited, in the composite layer 20, by making the Mn ratio of the LMFP on the separator side relatively low, the Mn elution can be suppressed more effectively than in other cases. In addition, Mn diffusing toward the negative electrode in the electrolyte can be suppressed, and as a result, the deterioration of cycle characteristics is considered to be suppressed.

The Mn ratio a and the Mn ratio c can be appropriately set within the ranges of 0<a<1.0 and 0<b<1.0, respectively, so that a<c.

### Mn Ratio a

The Mn ratio a is, for example, 0<a<0.80. In particular, in consideration of the energy density, the Mn ratio a is particularly 0.40 or more, 0.45 or more, 0.50 or more, 0.55 or more, or 0.60 or more. In addition, from the viewpoint of suppressing Mn elution and the viewpoint of electronic conductivity and ionic conductivity, the Mn ratio a is 0.75 or less, 0.70 or less, 0.65 or less, 0.60 or less, or 0.55 or less. The range of the Mn ratio a can be appropriately selected and set from these lower and upper limits. From the viewpoint of suppressing Mn elution, energy density, electronic conductivity, and the like, for example, the Mn ratio a can be set to 0.40 or more and less than 0.80, 0.40 or more and 0.75 or less, 0.40 or more and 0.70 or less, 0.50 or more and 0.70 or less, or 0.55 or more and 0.65 or less.

When the Mn ratio a is within the above range, the Fe ratio b is, for example, 0.20<b<1.0. In addition, for example, the lower limit of b is 0.25 or more, 0.30 or more, 0.35 or more, 0.40 or more, or 0.45 or more. The upper limit of b is 0.60 or less, 0.55 or less, 0.50 or less, 0.45 or less, or 0.40 or less. Therefore, b is, for example, more than 0.20 and 0.60 or less, 0.25 or more and 0.60 or less, 0.30 or more and 0.60 or less, 0.30 or more and 0.50 or less, or 0.35 or more and 0.45 or less.

### Mn Ratio c

From the viewpoint of energy density, the Mn ratio c is, for example, 0.70≤c<1.0. In addition, for example, c is 0.75 or more, 0.80 or more, or 0.85 or more. In addition, from the viewpoint of suppressing Mn elution and the viewpoint of electron conductivity, the Mn ratio c is, for example, 0.90 or less, 0.85 or less, 0.80 or less, or 0.75 or less. The range of the Mn ratio c can be appropriately selected and set from these lower and upper limits, such as 0.70 or more and 0.90 or less, 0.70 or more and 0.85 or less, 0.75 or more and 0.85 or less, for example.

When the Mn ratio c is within the above range, the Fe ratio d is, for example, 0<d≤0.30. In addition, for example, the lower limit of d is 0.10 or more, 0.15 or more, 0.20 or more, or 0.25 or more. The range of d can be appropriately selected and set from these lower and upper limits, such as 0.10 or more and 0.30 or less, 0.15 or more and 0.30 or less, 0.15 or more and 0.25 or less.

It is noted that other variables and the like in Formula (1) and Formula (2) can be set as follows.

With respect to a and p, each is within the range of 0.50 or more and 1.5 or less. When exceeding the range, the purity of the LMFP is excessively reduced, and the energy density is difficult to ensure. α and β are, for example, preferably within the range of 0.90 or more and 1.1 or less. The purity of the LMFP is sufficiently ensured, and the energy density is ensured. In addition, both a+b and c+d are 0.90 or more and 1.1 or less. When within the range, the purity of the LMFP is ensured, and the energy density is ensured.

The LMFP disclosed in the present specification is a compound represented by Li_{α}MnₐFe_{b}PO₄ and Li_{β}Mn_{c}Fe_{d}PO₄. As a doping element, elements other than the elements described above, when added to the LMFP in a range of 0.1% by mass or more and 10% by mass or less, are also included in the LMFP of the present disclosure.

The composition of the LMFP can be specified by atomic absorption analysis for lithium and ICP emission analysis for manganese, iron, and phosphorus. Two significant digits are adopted for the variables α, β, a to d. In addition, when a raw material charging ratio during manufacturing the LMFP is known, the composition can also be obtained from the charging ratio.

An average particle diameter of the first LMFP 26 and an average particle diameter of the second LMFP 28 are not particularly limited.

The first LMFP 26 and the second LMFP 28 may include a carbonaceous coating for improving electronic conductivity. The carbonaceous coating can include, for example, a carbonaceous material such as graphite or semi-graphite. The thickness of the carbonaceous coating is not particularly limited. For example, the thickness may be 0.1 nm or more and 10 nm or less, or 0.5 nm or more and 3 nm or less.

In the first region 22 and the second region 24, the first LMFP 26 and the second LMFP 28 are contained, respectively, as positive electrode active material particles at, for example, 70% by mass or more, 80% by mass or more, 85% by mass or more, 95% by mass or more, 98% by mass or more, or 100% by mass with respect to the total mass of the positive electrode active material particles. The first region 22 and the second region 24 may include other active material particles in addition to the first LMFP 26 and the second LMFP 28. For example, particles containing a known other olivine-type positive electrode material can be used. Examples of the olivine-type positive electrode material include lithium iron phosphate (LiFePO₄, LFP) and lithium manganese phosphate (LiMnPO₄, LMP). In addition, a known layered rock-salt-type oxide such as NCM can also be included.

A content (total amount) of the positive electrode active material particles in the composite layer 20 is not particularly limited, but is, for example, 80% by mass or more, 90% by mass or more, 95% by mass or more, 96% by mass or more, or 97% by mass or more with respect to the total mass of the composite layer 20.

### Conductive Additive

The first region 22 and the second region 24 may each contain a conductive additive. The conductive additive is an additive for improving electronic conductivity in the composite layer 20. The conductive additive is not particularly limited, and various known conductive additives can be used. Examples of the conductive additive include graphite such as natural graphite and artificial graphite; carbon blacks such as acetylene black, Ketjen black, channel black, furnace black, lamp black, and summer black; conductive fibers such as carbon fiber and metal fiber; carbon materials such as graphene and carbon nanotube; fluorinated carbon; metal powders such as aluminum and nickel powders; conductive whiskers such as zinc oxide and potassium titanate; conductive metal oxides such as titanium oxide; and conductive materials such as polyphenylene derivatives. As the carbon nanotube, for example, a single-wall carbon nanotube (SW-CNT) or a multi-wall carbon nanotube (MW-CNT) including a double-wall carbon nanotube may be preferable. One or two or more of these can be used as the conductive additive.

A content (total amount) of the conductive additive in the composite layer 20 is not particularly limited, but is, for example, 0.01% by mass or more and 5% by mass or less with respect to the total mass of the composite layer 20.

### Binder

The composite layer 20 can contain a binder. The binder is not particularly limited, and a known binder used for the positive electrode can be appropriately used. Examples thereof include polyvinylidene fluoride and styrene butadiene rubber. One or two or more of these can be used. A content of the binder in the composite layer 20 is not particularly limited, but is, for example, 0.3% by mass or more and 10% by mass or less.

A thickness of the composite layer 20 is not particularly limited, but is, for example, a thickness of about 10 μm or more and 500 μm or less. In addition, a thickness of each of the first region 22 and the second region 24 is not particularly limited, but may be, for example, a thickness that equally divides the thickness of the composite layer 20 into two.

According to the present specification, there is also provided a secondary battery 100 in which cells 2 each including such a positive electrode 4, a separator 6, a negative electrode composite layer 30, and a negative electrode current collector 12, are laminated.

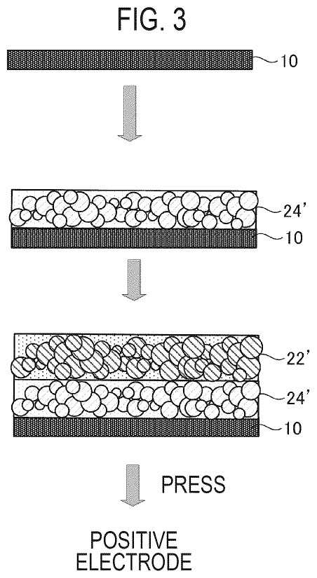

Next, a method of manufacturing the positive electrode 4 will be described with reference to FIG. 3 as appropriate.

In the manufacturing method, a mixture for a positive electrode composite layer corresponding to the second region 24 is coated onto the current collector 10 by a known method such as doctor blade, and dried as necessary. Then, a precursor layer 24′ of the second region 24 is prepared, and further, a composition for a positive electrode composite layer corresponding to the first region 22 is coated onto the precursor layer 24′. Then, a precursor layer 22′ of the first region 22 is prepared, dried, and pressed. In this manner, the positive electrode 4 can be obtained in which the composite layer 20 is integrated with the current collector 10.

The various aspects of the second region 24 and the first region 22 described above are applied to the mixture for a positive electrode composite layer corresponding to the second region 24 and the mixture for a positive electrode composite layer corresponding to the first region 22, respectively.

According to the manufacturing method, by laminating the LMFPs having different Mn ratios in the composite layer 20, the secondary battery 100 having excellent cycle characteristics and the like can be easily obtained by suppressing the amount of Mn elution. The secondary battery 100 using the positive electrode 4 can be manufactured with reference to a known method as appropriate.

Hereinafter, Examples in which the disclosure of the present specification is embodied will be described, but the Examples are for illustrative purposes only and are not intended to limit the scope of the disclosure of the present specification.

### Example 1

In the present Example, a lithium-ion secondary battery was produced by the following method, and the cycle characteristics and the amount of Mn elution were measured under predetermined conditions. Table 1 shows the configurations of the sample and the comparative example sample.

### (1) Production of Positive Electrode

The positive electrode of Sample 1 was produced as follows. That is, as the positive electrode active material, LMFPII (Mn: 80 mol %, Fe: 20 mol %) and LMFP I (Mn: 60 mol %, Fe: 40 mol %) were used, and the composite slurries were prepared such that the ratio of LMFP: conductive additive: binder was 98:0.1:1.9 (% by mass). These slurries were coated onto the current collector (30 μm thick) using doctor blade to obtain the electrode structure shown in Table 1, with the layers having substantially the same thickness and a total coating weight of 20 mg/cm². Thereafter, the coating was dried at 100° C. for 10 minutes, and pressed such that the density was 2.0 g/cc to produce the positive electrode of Sample 1.

For Comparative example samples 2 to 4, positive electrodes were produced by the same operation as in Sample 1, except that the composite slurries were prepared and coated such that the electrode structures having the configurations shown in Table 1 were obtained.

### (2) Production of Negative Electrode

Graphite was used as the negative electrode active material, and a slurry having a ratio of active material: conductive additive: CMC: SBR=97:0.1:0.4:2.5 (% by mass) was produced. Then, the slurry was coated onto one side of a Cu foil of 8 μm using doctor blade to achieve a one-side coating weight of 13 mg/cm² (the ratio of the positive electrode capacity to the negative electrode capacity was 1.1), followed by drying at 100° C. for 10 minutes, and pressing such that the density was 1.3 g/cc to produce the negative electrode.

### (3) Production of Cell

Each of the positive electrodes of the sample and the comparative example sample, the separator (a three-layer laminate of PP/PE/PP, 16 μm), and the negative electrode were laminated to produce a laminated cell. As the electrolytic solution, a 1.4 M LiPF₆/FSI mixed system was used with EC:DMC:EMC=30:40:30 (% by volume). The cell restraining pressure was set to 100 kPa.

### (4) Activation, Evaluation of Capacity Retention Rate at 40° C., and Measurement of Amount of Mn Elution

The initial charging current was set to a constant current-constant voltage method, in which constant current charging was performed at a current value of 0.05C up to 4.3 V, followed by constant voltage charging until the current value reached 0.02 C, and then discharging was performed using a constant current method at a current value of 0.05 C down to 3.0 V, thereby activating the battery. After the cycle (200 cycles), charging was performed up to 4.3 V at a current value of 0.1 C using a constant current-low voltage method, followed by discharging down to 3.0 V at a current value of 0.1 C using a constant current method, and the capacity retention rate with respect to the rated capacity was calculated. The results are shown in Table 1.

The amount of manganese elution after 200 cycles was evaluated according to a predetermined method. The results are shown in Table 1.

TABLE 1

| | | | | | | | | | | Amount |
|---|---|---|---|---|---|---|---|---|---|---|
| | | | | | | | | | | of Mn |
| | | | | | LMFP I | | LMFP II | | Capacity | Leaching |
| | | | | | | Amount | | Amount | Retention | (ppm) after |
| | | | | | Mn/Fe | Mixed in | Mn/Fe | Mixed in | Rate after | 200 cycles |
| | | | | | Ratio | Electrode | Ratio | Electrode | 200 cycles | at 40° C. |
| Type | | Electrode Structure | | | mol % | % by mass | mol % | % by mass | at 40° C. % | ppm |
| Example | 1 | Two- | Separator | Current- | 60/40 | 50 | 80/20 | 50 | 85 | 0.12 |
| | | Layer | Side | Collector | | | | | | |
| | | | LMFP | Side | | | | | | |
| | | | | LMFP | | | | | | |
| | | | I | II | | | | | | |
| Comparative | 1 | Two- | Separator | Current- | 60/40 | 50 | 80/20 | 50 | 77 | 0.19 |
| Example | | Layer | Side | Collector | | | | | | |
| | | | LMFP | Side | | | | | | |
| | | | | LMFP | | | | | | |
| | | | II | I | | | | | | |

| | | | | | | | | |
|---|---|---|---|---|---|---|---|---|
| 2 | Single | I | 60/40 | 0 | 80/20 | 100 | 74 | 0.22 |
| | Layer | | | | | | | |
| | (Single) | | | | | | | |
| 3 | Single | I/II | 60/40 | 30 | 80/20 | 70 | 66 | 0.19 |
| | Layer | | | | | | | |
| | (Mixed) | | | | | | | |
| 4 | Single | I/II | 60/40 | 50 | 80/20 | 50 | 80 | 0.17 |
| | Layer | | | | | | | |
| | (Mixed) | | | | | | | |

As shown in Table 1, in a comparison between Sample 1 and Comparative example sample 1, the capacity retention rate was improved and the amount of Mn elution was also reduced by disposing the LMFP having a smaller Mn ratio in the first region (separator side). From this, it was found that, when producing the positive electrode having a laminated structure based on differences in the Mn ratio, it was useful to use the LMFP having a smaller Mn ratio on the separator side.

In addition, in a comparison between Sample 1 and Comparative example samples 2 to 4, it was found that, by disposing the LMFP having a smaller Mn ratio on the separator side, a higher capacity retention rate and a lower amount of Mn elution could be achieved as compared to a single layer of the LMFP having a larger Mn ratio. Furthermore, it was found that, by disposing the LMIFP having a smaller Mn ratio on the separator side, a higher capacity retention rate and a lower amount of Mn elution could be achieved as compared to a single layer in which the LMFP having a larger Mn ratio and the LMFP having a smaller Mn ratio were simply mixed.

From the above, it was found that, by adopting the laminated structure in which the LMFP having a smaller Mn ratio was used on the separator side and the LMFP having a larger Mn ratio was used on the current-collector side in the positive electrode composite layer, the amount of Mn elution could be easily and efficiently suppressed, and the cycle characteristics could be maintained or improved.

Although specific examples of the technology disclosed in the present specification have been described in detail above, these examples are merely illustrative and do not limit the scope of the claims. The technology described in the claims includes various modifications and changes of the specific examples exemplified above. The technical elements described in the present specification or the drawings exhibit technical usefulness alone or in various combinations and are not limited to the combinations described in the claims at the time of filing. The technology exemplified in the present specification or the drawings can achieve a plurality of objectives at the same time, and achieving one of the objectives has technical usefulness.

What is claimed is:

1. A positive electrode of a lithium-ion secondary battery, the positive electrode comprising:
a first region facing a separator; and
a second region facing a current collector,
wherein the first region contains a first lithium manganese iron phosphate represented by Formula (1) as a general formula, the second region contains a second lithium manganese iron phosphate represented by Formula (2) as a general formula, and a<c,
$${Li}_{α} {Mn}_{a} {Fe}_{b} {PO}_{4} ( 0.5 \leq α \leq 1.5 , 0 < a < 1. , 0 < b < 1. , 0.9 \leq a + b \leq 1 \text{.1} ) \qquad Formula ( 1 )$$
$${Li}_{β} {Mn}_{c} {Fe}_{d} {PO}_{4} ( 0.5 \leq β \leq 1.5 , 0 < c < 1. , 0 < d < 1. , 0.9 \leq c + d \leq 1 \text{.1} ) . \qquad Formula ( 2 )$$

2. The positive electrode according to claim 1, wherein, in the Formula (1), 0<a<0.80 and 0.20<b<1.0, and in the Formula (2), 0.70≤c<1.0 and 0<d≤0.30.

3. The positive electrode according to claim 2, wherein, in the Formula (1), 0<a≤0.60 and 0.40≤b<1.0.

4. The positive electrode according to claim 3, wherein, in the Formula (1), 0.55≤a≤0.65 and 0.35≤b≤0.45, and in the Formula (2), 0.75≤c≤0.85 and 0.15≤d≤0.25.

5. A lithium-ion secondary battery comprising the positive electrode according to claim 1.
